(19) United States
(12) Patent Application Publication
(10) Pub. No.: US 2014/0363799 A1
(43) Pub. Date: Dec. 11, 2014

(54) Mobile Application For Martial Arts Training

(71) Applicant: Richard Ivan Brown, Northbrook, IL (US)

(72) Inventor: Richard Ivan Brown, Northbrook, IL (US)

(21) Appl. No.: 14/296,413

(22) Filed: Jun. 4, 2014

Related U.S. Application Data
(60) Provisional application No. 61/956,360, filed on Jun. 6, 2013.

(51) Int. Cl. G09B 5/06; G09B 19/00

(52) U.S. Cl. CPC G09B 5/065; G09B 19/003
USPC 434/247

(57) ABSTRACT

Examples and embodiments provide systems, methods, and apparatus to provide information and instruction to those involved in Martial Arts training via a mobile device, such as a smartphone. A mobile application provides various training functions including, by limited to a handbook; flash cards; stretching, fundamental skills, advanced techniques, and sparring practice routines. The routines can be preloaded within the mobile application and/or specifically created by the student or instructor. Routines can be executed at user selected rates and presented audibly and/or visually as elected by the user. The mobile application can be used individually and/or in a class room setting.

### RELATED APPLICATION

This application is a continuation of provisional U.S. patent application Ser. No. 61/956,360, filed on Jun. 6, 2013.

### FIELD

The present invention relates generally to methods, systems, and apparatus to provide students and instructors with mobile applications for Martial Arts training.

### BACKGROUND

Many forms of Martial Arts are practiced and taught with students and practitioners of all ages. The most effective training occurs when an instruction can actually work with the student. The student will later practice at home what he or she has learned in class, usually by his or herself, relying on memory, and, in some cases, referring to a manual or handbook. There are also books and videos available for some of the more popular Martial Arts and some techniques and Katas can be found on internet web sites like YouTube. But little is available to help the student improve reaction times when called up to execute a defensive technique during classroom drills or promotion tests, nor respond more effectively during classroom sparring, or during actual street attacks. And further, manuals and videos do not help the student learn a new technique or Kata in a step by step manner while being able to freely maneuver about and have both hands free to strike and defend. Nor are there effective tools to assist the Martial Arts instructor in class. And so there remains a need to improve Martial Arts training method, systems and apparatus for the benefit of both students and instructors.

### BRIEF SUMMARY

Systems, methods, and apparatus are provided to convey information to assist in Martial Arts training.

One aspect of the invention provides methods to computer-implemented access present data contained in files held in memory.

Another aspect provides the student with a computer-implemented disciplined approach to stretching during a practice session.

Yet another aspect provides a method to more rapidly bring the elements of a defensive technique or techniques to mind.

Still other aspects of the mobile Martial Arts training application provide computer-implemented methods, apparatus, and systems to hone the student's reaction time and mastery of fundamental, advanced, and sparring skills.

Computer-implemented methods provide graphical and/or audible representation of one or more defensive techniques, the methods further providing variable time based rates of presentation.

Some embodiments provide a tangible computer readable storage medium including program code for execution by a processor, the program code, when executed, to implement various Martial Arts training and/or instruction procedures. The methods include providing a graphical and/or audible representation of one or more defensive techniques. The graphical and/or audible representation visually and/or audibly conveys a series to time based instruction to the Martial Arts student to improve the student's reaction time to particular events.

### BRIEF DESCRIPTION OF SEVERAL VIEWS OF THE DRAWINGS

FIGS. 1a-b show a mobile device and user interface.

FIGS. 2a-2b show file structures embodiments for use in a mobile application for training students in Martial Arts.

FIGS. 3a-b show example interfaces for a stretching routine.

FIG. 4 illustrate a user interface to change variable in the mobile application.

FIGS. 5a-f show aspects of the mobile application to provide audible and/or visual information about Martial Arts techniques.

FIGS. 6a-c illustrate the user interface associated with one aspect of the invention to help the Martial Arts student practice various techniques and improve reaction time.

FIGS. 6d-h show the user interfaces for Martial Arts students and instructors to create and save new practice routines.

FIGS. 7a-d depict the another aspect of the mobile application being used to help sharpen the Martial Artist's sparring skills.

FIGS. 7e-f show how the mobile application deletes and/or renames previously saved practice routines.

The foregoing summary, as well as the following detailed description of several embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DESCRIPTION

Illustrative examples are shown in the above-identified figures and described in detail below. In describing these examples, like or identical reference numbers are used to identify the same or similar elements. The figures are not necessarily to scale and certain features and views of the figures may be shown exaggerated in scale or in schematic for clarity and/or conciseness. Additionally, several examples have been described throughout this specification. Any features from any example may be included with, a replacement for, or otherwise combined with other features from other examples.

It will be understood that the present invention may be embodied in other specific forms without departing from the spirit thereof. The present examples and embodiments, therefore, are to be considered in all respects as illustrative and not restrictive, and the invention is not to be limited to the details presented herein.

Although the following discloses example methods, apparatus, systems, and articles of manufacture including, among other components, firmware and/or software executed on hardware, it should be noted that such methods, apparatus, systems and articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

### Illustrative Device

A mobile application on a handheld computing device (e.g., an Apple iPad™ iPhone™, and/or other tablet computer or smartphone) can enhance one or more aspects of Martial Arts training. The illustrative mobile device presented herein is an Android based smartphone.

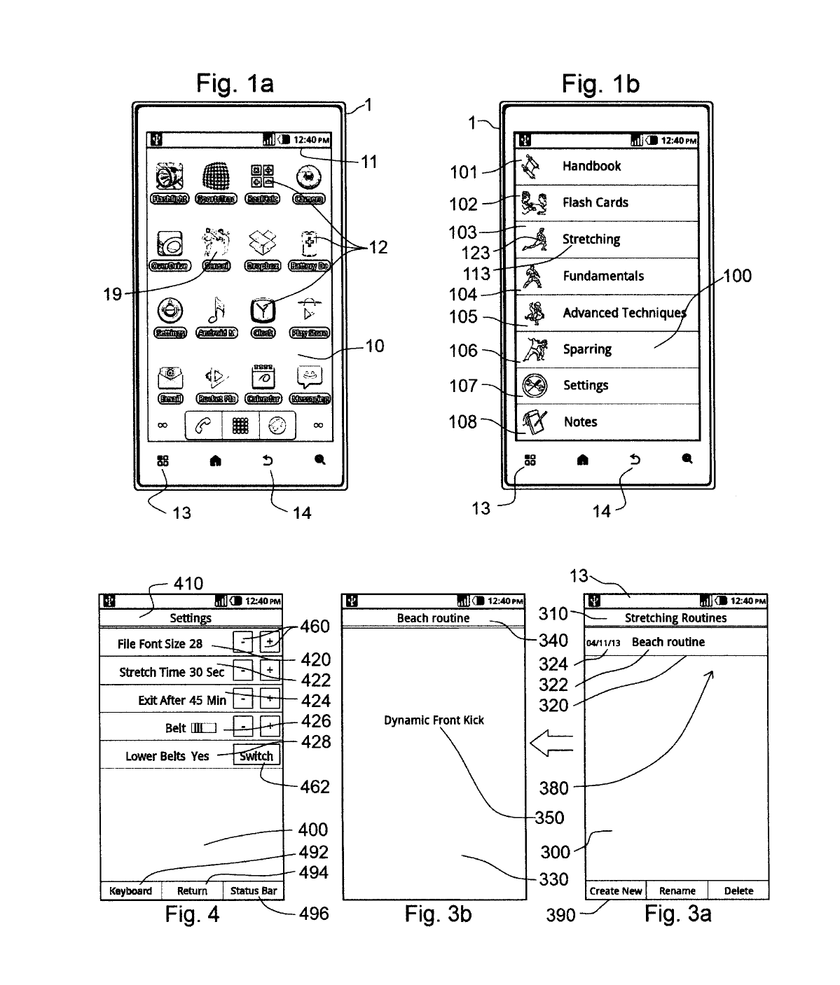

FIG. 1a shows Motorola Triumph android based smartphone 1 having touch-sensitive screen 10. Home screen 10 includes status bar 11 and a number of application specific icons 12. Smartphone 1 has multiple controls of which menu key 13 and back key 14 are especially useful in the instant mobile application. Tapping Martial Arts training icon 19 activates the subject mobile application, bringing up screen 100 of FIG. 1b.

### An Illustrative Mobile Application and Navigation Therethrough

Screen 100 shows the main menu of the subject Martial Arts training application. Screen 100 provides the user with selectable functions 101-108 wherein each function provides a different aspect a Martial Arts training program. Eight functions are shown, but the number is not limiting as some functions could be combined while others could be divided into multiple functions. Additional functions can also be call up by tapping menu key 14 if desired. The illustrative embodiments provide various training for the Martial Art of Kempo Karate, but the mobile application is not limited to that art. The operation and structure of the mobile application discussed below could just as easily be applied to any of more than three thousand Martial Arts practiced around the world today.

Particular functions are selected by tapping its window, icon, button, etc. in a known manner. Back key 14 can be used to back up one screen during use, and to exit the application and return to home screen 10 of FIG. 1a when the user is on screen 100 of FIG. 1b. Other means of navigating the various screens of the mobile application can also be used. For instance, a “Back” icon can be included in any screen and the application can be programmed so that swiping a finger across a screen will return to the previous screen.

### Exemplary File Structures

Kempo Karate, like other Martial Arts, includes different type of kicks and punches, multiple blocking systems and techniques designed to defend against armed and unarmed assailants. The illustrative mobile application provides functions 101-108 to help the student master these skills. Each function can include a label naming the function, such as Stretching 113 of function 103 and/or a descriptive icon, such as icon 123 depicting a Martial Artist in the act of stretching. Icons can suggest something about the topic and allow pre-school children to use many features of the application.

As shown in FIG. 1b, the functions have been arranged in a list, but other arrangements can be used. For instance, screen 100 could be executed in the user arrangeable icon style of smartphone 1 home screen 10 of FIG. 1a. The illustrative functions are listed below.
Function 101—Handbook—provides the user with methods to better understand the definitions, explanations, and mastery of the different aspects of the art.
Function 102—Flash Cards—provides a method to exercise the students ability to quickly bring a technique to mind.
Function 103—Stretching—provides stretching routines for use before and after a practice session.
Function 104—Fundamentals—provides methods to practice punching, kicking and blocking.
Function 105—Advanced Techniques—provides methods by which the student can work techniques design to counter armed and unarmed attacks.
Function 106—Sparring—provides methods to improve reaction times against randomly occurring attacks.
Function 107—Settings—provides a method to allow the student to customize the mobile application.
Function 108—Notes—provides a method for the student to record personal notes and observations about the techniques or upcoming events.

Data in one form or another is associated with each of functions 101-108; some as part of the mobile application's database, and others as files and preferences created by the user. The data can be stored in the phone's internal memory, on an installed Secure Digital memory card, or SD card, a connected external drive, on an internet based web site, in the user's so-called internet based cloud storage, etc. As used herein, SD card is a non-specific designation and can apply to any memory source associated with or in communication with the device, such as so-called Internet based cloud storage.

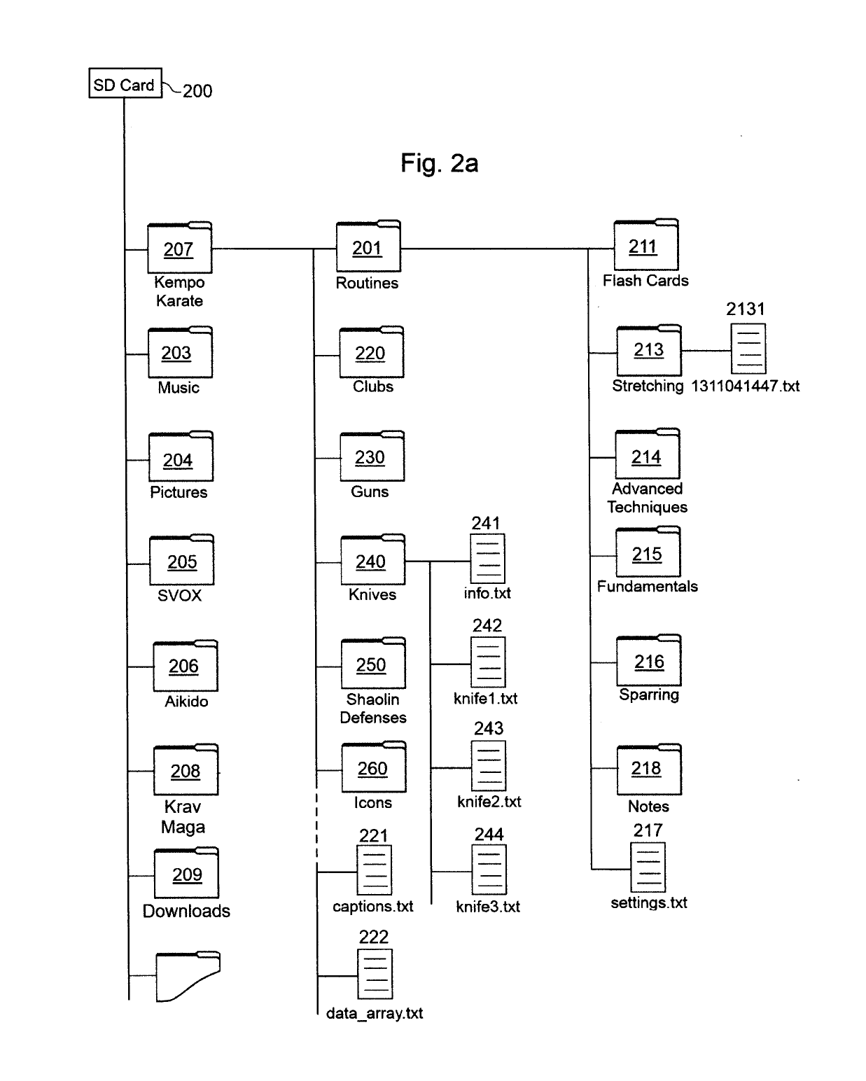

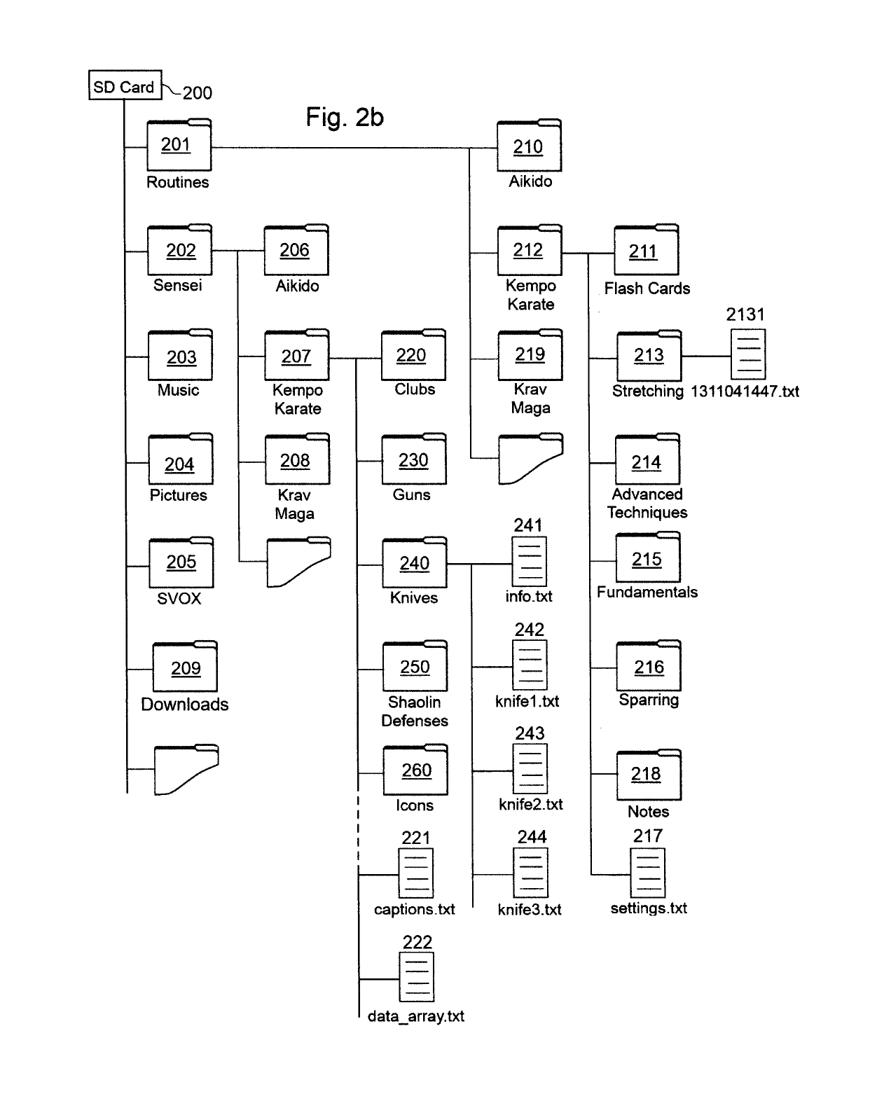

Data associated with the illustrative mobile application can be in the form of text files, Portable Document Format (PDF), bitmaps, image, music and/or video files, etc. (.txt, .jpg, .pdf, .mp3, etc.) located in directories, or folders in memory. The file structure of one embodiment is shown in FIG. 2a. SD Card 200 includes Kempo Karate folder 207 that can contain some, or all, of the data associated with the mobile application. It can also include Downloads folder 209, Music folder 203, Pictures folder 204, and SVOX folder 205 that can also contain additional data that can be used in the mobile application. For instance, SVOX folder 205 includes voice data for use with the text-to-speech engine resident in smartphone 1. Pictures, Music, and Download folders 204, 203, and 209 can contain music, images and downloaded videos all useable in the mobile application.

The mobile application can be adapted to other forms of Martial Arts. Some Martial Artists cross train several different arts and each art can have its own separate training application. For instance Aikido folder 206 and Krav Maga folder 208 can include data folders and files adapted specifically to the Aikido and Krav Maga Martial Arts.

Alternatively, a single Martial Arts training application can comprise a universal Martial Arts training engine adapted to operate in conjunction with any particular Martial Arts databases, as shown in FIG. 2b. Sensei folder 202 on SD Card 200 includes separately acquired Aikido folder 206, Kempo Karate folder 207, and Krav Maga folder 208. When activated, the Sensei mobile application would first give the student a choice of which art to practice.

As will be discussed below, several of the functions 101-108 of screen 100 have associated student generated files, herein collectively referred to as user routines. The file structure of FIG. 2b illustrates how those files can be made independent of the Sensei folder 202 files to simplify mobile application updates. Routines folder 201 is part of the SD Card 200 directory, isolating its contents from Sensei folder 202. Alternatively, Routines folder 201 can be included in Sensei folder 202, but independent of Martial Arts folders 206-208. Additional details of file structure FIGS. 2a and 2b will be discussed subsequently.

### Operation of the Mobile Application

Each Function 101-108 provides a different training aspect, each capable of standing alone as a separate mobile application. All functions are initiated in the function's 101-108 window.

### The Stretching Function

Tapping Function 103 of screen 100 brings up Stretching screen 300 shown in FIG. 3a. Screen 300 comprises header 310 identifying the Function, footer 390 providing various options to be discussed later, and list 380 tabulating stored stretching routines, if any. Stored routines can be included as part of the original mobile application installed on the device and/or can be created by the user. In this case, exemplary list 380 consists of single routine 320, said routine having name Beach routine 321 and optionally including its Apr. 11, 2013 date of creation 324.

Screen 300 and other screens of the mobile application can also optionally display status bar 11 if desired by the user. Status bar 11 displays time, battery strength, phone signal strength, wireless connections, email and text messaging notifications and the like. It can be turned off if desired as will be discussed later.

Beach routine 320 is saved as text file 2131 in Stretching folder 213 within Routines folder 201 as part of Kempo Karate folder 207 of FIG. 2a, or as text file 2131 in Stretching folder 213 within Kempo Karate folder 212 within Routines folder 201 of FIG. 2b. Text file 2131 is stored herein as 1311041447.txt, which is a date base naming system based on year, month, day, hour, and minute to facilitate ordered sorting.

Similarly stored routines can reside in Flash Cards folder 211, Advanced Techniques folder 214, Fundamentals folder 215, Sparring folder 216 and Notes folder 218 of FIGS. 2a and 2b. Aikido and Krav Maga folders 206 and 208 of FIG. 2a can likewise contain a Routines folder 201 with sub-folders in name and number as appropriate to those arts. Similarly, Aikido and Krav Maga folder 210 and 219 within Routines folder 201 of FIG. 2b can contain routine folders similar to those contained in Kemp Karate folder 212.

Beach routine 1311041447.txt file 2131 includes the name to appear as FIG. 3a routine name 322, the date code to appear as creation date 324, the number of included stretches, and a list of stretching exercises selected by the student, discussed later, as shown in Exemplary File 1 below:

| Exemplary File 1 | (Text file 1311041447.txt 2131) |
|---|---|
| Beach routine | (routine name) |
| Apr. 11, 2013 | (creation date) |
| 11 | (number of included stretches) |
| Dynamic Front Kick | |
| Dynamic Side Pointer | |
| Dynamic Side Blade | |
| Dynamic Back Kick | |
| Crane Drinks Water | |
| Crane Lean LR | |
| Sumo | |
| Standing Quad LR | |
| High Shoulder Press LR | |
| Torso Twist | |
| Front Split LR | |

Tapping Beach routine 320 begins the selected stretching routine, annunciating each individual stretch through internal or external speakers, attached ear buds, or a wirelessly connected headset using a text-to-speech engine resident in the device (not shown), or as pre-recorded voice files in mp3, etc. format. Tapping Beach routine 320 also brings up screen 330 having header 340 identifying which routine is being executed and specific stretch name 350. The stretching routine will continue to execute even if the display screen of smartphone 1 is turned off to conserve battery power and prevent inadvertent triggering if smartphone 1 is pocketed to free up the students hands. Each stretch is held for a preselected period of time before the next stretch is announced, for instance 30 seconds. Stretches ending in LR in Exemplary File 1 designate that that particular stretch is to be performed bilaterally, invoking the annunciation of “on one side” followed the preselected period of time later by “now on the other”. The LR designation is stripped from the stretch name before it is announced and displayed.

### The Settings Function

The preselected stretching time can be changed by tapping Settings Function 107 window of screen 100 of FIG. 1b, calling up Settings screen 400 of FIG. 4. Screen 400 includes header 410 identifying the function, and a list of user changeable setting comprising, but not limited to, file font size 420, stretch time 422, automatic exit time 424, user belt level 426, and whether to include lower belts in group selections processes 428. Screen 400 further includes a matrix of plus and minus buttons 460 used to change the variables values 420-426. User belt 426 is shown as an icon representing the belt level selected, although textual names could be used as well. The screen further include button 462 to toggle between whether to include lower belts in technique selection processes or not. Screen 400 further includes “Keyboard” button 492 to select between keyboard and voice recognition type data inputs, “Status” button 496 to set whether to display status bar 11 or not, and “Return” button 494 to return to the previous screen. Settings screen 400 can also be reached by tapping menu key 13 on smartphone 1.

The mobile application looks to Kempo Karate folder 212 of FIGS. 2a-2b to settings.txt file 217 at startup to determine what value should populate the settings on screen 400. The mobile application rewrites settings.txt file 217 each time the settings of screen 400 are changed so that the user's new choses will be loaded at the next startup.

### The Handbook Function

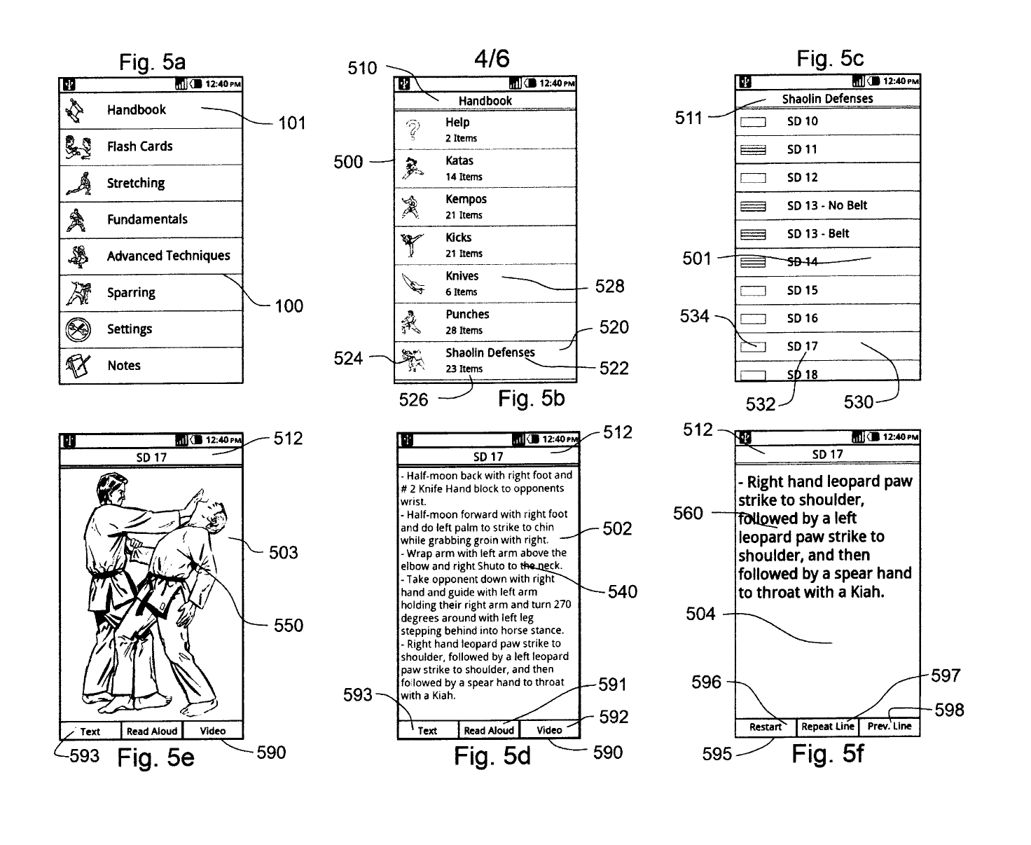

Tapping Handbook Function 101 on screen 100, here repeated in FIG. 5a, brings up screen 500 of FIG. 5b having Handbook header 510 confirming the selection. The Handbook function provides the student with means to look up and study each of the hundreds of text files describing the different types of kicks, punches, forms, defenses, etc. held in the data base. The function further provides the student with lists of requirements needed to advance to the next belt level, directions on how to use the mobile application, expected codes of conduct, the like, etc. If there are more topics than will fit on screen 500, the remaining topics, or categories, can be brought into view by dragging a finger up or down the screen to scroll through the list. A typical topic or category window 520 can include, but is not limited to, topic name 520, here Shaolin Defense, topic icon 524, and indicia 526 indicating how many items are included in the category.

The topic windows of FIG. 5b are associated with specific folders in FIGS. 2a-2b. For instance, Shaolin Defense topic window 520 refers to Shaolin Defense folder 250, and Knives topic window 528 refers to Knifes folder 240 of FIGS. 2a-2b. The folders 240 and 250 can contain as many files and folders as required to describe included techniques and the like, and typically include info.txt file 241 describing attributes of the folder as shown in Exemplary File 2 below:

| Exemplary File 2 | (Info.txt 241) |
|---|---|
| Knives | (Folder's name for display in lists) |
| knives.png | (Icon to be displayed in lists) |
| 6 | (total number of included techniques) |
| 110010 | (binary number identifying applicable functions) |

The first line gives the name to be used in the topic window, here Knives, and the image file name of icon to appear, here knives.png, although other formats like .jpg or .tif, etc. can also be used. The image file can be located in Knives folder 240, or in Icons folder 260, as is the case here. The next line lists the number of different knife defenses held in folder 240 and appearing as indicia 528 on screen 500. The last line is a binary number identifying in which Functions 101-108 the folder is to be included. The number 110100 indicates that Knives 240 data is to be used in the Handbook 101, Flash Card 102, and Advanced Techniques 104 functions, but not in the Stretching 103, Fundamentals 104, or Sparring 106 functions.

Tapping topic window 520 calls up screen 501 in FIG. 5c. Screen 501 includes header 511 citing which topic or category has been selected and a list of the items held in topic window 520 of screen 500. Each item listed on screen 501 has an item selection window 530 that can include, but is not limited to, item name 532, here SD 17, and icon 534, here an image of the belt level at which the item is taught. Each item listed has an associated text file held in an associated topic folder in the data bases shown in FIGS. 2a-2b, for instance text files 242-244 containing information about knife defenses knife1, knife2, knife3, etc. A typical data files text, here knife2.txt 243 held in the Knives folder 240 can include, but is not limited to, specific attributes about the technique, as shown in Exemplary File 3 below:

| Exemplary File 3 | (knife2.txt 243) |
|---|---|
| Stabbing Knife 2 | (Technique's display name) |
| 0 | (Applicable belt level) |
| 4.0 | (Effective number of steps) |

Left palm block to grab side of knife hand around wrist while gating right back into side facing horse.
Catch other side of knife hand with right and hold like hamburger.
Bring right back into a front facing horse while pressing thumbs into back of hand in wrist lock, pulling the wrist into chest.
Gate left foot back and around keeping knife hand close to chest and squatting down to bring him to the ground.

The first line is the name that will appear in the item windows of screen 502, discussed below, here Stabbing Knife 2. The second indicate at what belt level the defense is taught, here 0 indicating that it can be taught at any belt level. In Kempo Karate, belt level of 3 would indicate that the technique is taught at the Orange belt level, and an Orange belt icon would appear in the associated item window of screen 502. The third line indicates how many actual or apparent steps are involved in the technique. As will be seen later, the number does not need to be a whole number. The final lines describe the actual technique.

Tapping item selection window 530 on screen 501 of FIG. 5c calls up screen 502 of FIG. 5d. Screen 502 includes header 512 indicating which item has been selected, here SD 17, and text 540 displaying the description included in the text file associated with the item selected. The student can change the font size used to display the file by tapping menu key 13 on smartphone 1 in FIG. 1a to bring up screen 400 of FIG. 4 if so desired, returning to screen 502 when done. Screen 502 of FIG. 5d also includes options footer 590 offering the student other ways to interact with the data. Tapping “Video” button 592 brings up a video presentation of the technique, if available, as shown on screen 503 of FIG. 5e. Screen 503 also includes header 512 and options footer 590, identifying what is being watched and providing other options. Videos can be stored on SD Card 200 of FIGS. 2a-2b, or downloaded from the internet via cloud storage or redirection to web sites like YouTube. Tapping “Text” button 593 returns the student to screen 502 of FIG. 5d.

Tapping “Read Aloud” button 591 causes the mobile application to read the instructions audibly to the student, one line at a time. This is a particularly useful option as it allows the student to turn off the screen display and pocket or set aside the device while walking through the technique as a way of learning it without having to read the steps as though guided by an instructor. Tapping “Read Aloud” button also brings up screen 504 of FIG. 5f and provides the student a large print line by line presentation 560 of the technique if the student wishes to also read it. Screen 512 includes identifying header 512 and new options footer 595. Tapping “Restart” button 596 restarts the technique, tapping “Repeat Line” button 597 repeats the line, and tapping “Prey. Line” button 598 presents the previous line of the technique. The functions of FIGS. 5d-5f repeat as long as the student desires, ending only when back key 14 is tapped.

### The Advanced Techniques Function

Advanced Techniques are generally multi-step techniques deigned to defend against armed and unarmed attacks. Each is relatively complicated and takes a significant amount of practice before the technique becomes second nature. The Advanced Techniques function provides means to help the student physically practice in an active and stimulating manner.

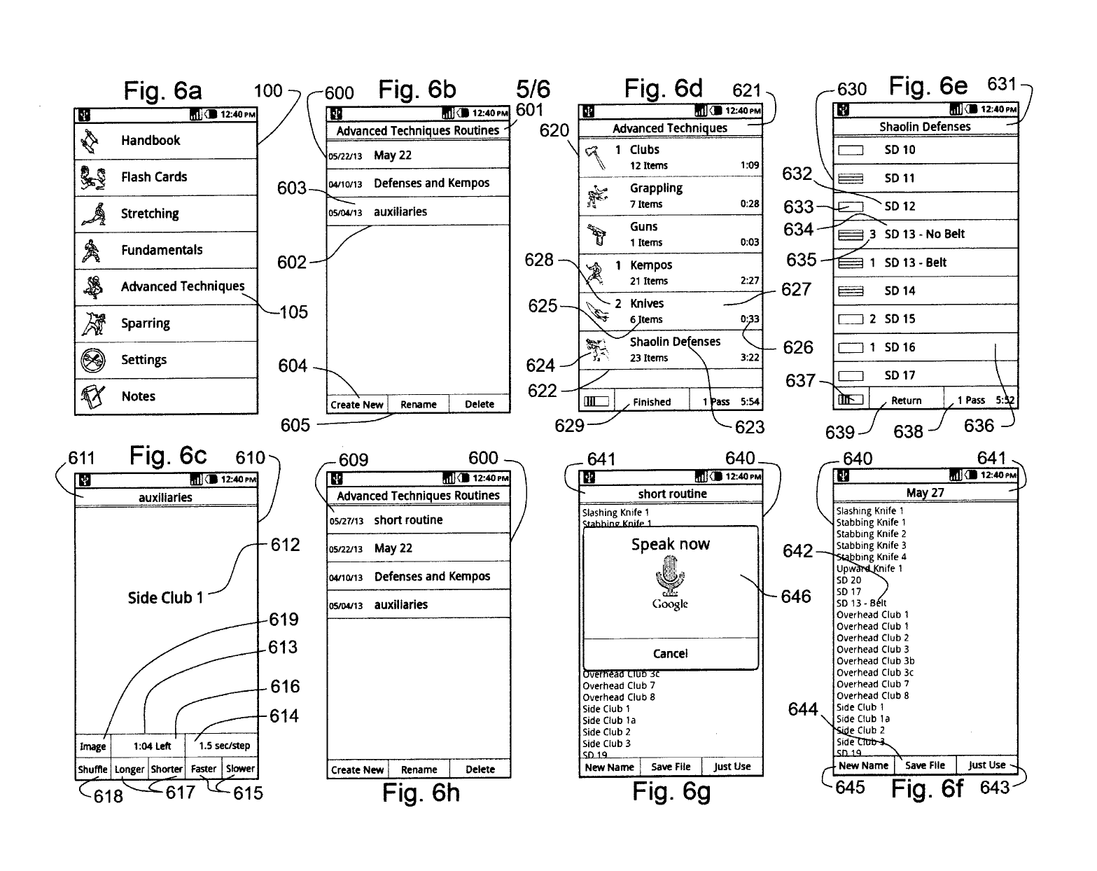

Tapping Advanced Technique window 105 on screen 100 of FIG. 6a initiates the function, calling up screen 600 as shown in FIG. 6b. As with other screens, screen 600 includes header 601 confirming the student's selection and options footer 605. Screen 600 further includes list 602 of previously created routines stored in Advanced Techniques folder 214. Each routine in list 602 has a selection window displaying the routines name and date of creation as has been discussed above in the Stretching Function. The text file associated with the “auxiliaries” routine is shown below.

Exemplary File 4

| | |
|---|---|
| auxiliaries | (routine name) |
| May 04, 2013 | (creation date) |
| 23 | (number of included techniques) |
| 3.0 Overhead Club 1 | (effective number of steps technique name) |
| 4.0 Overhead Club 2 | |
| 4.7 Overhead Club 3 | |
| 5.3 Overhead Club 3b | |
| 6.0 Overhead Club 3c | |
| 5.0 Overhead Club 7 | |
| 4.0 Overhead Club 8 | |
| 3.0 Side Club 1 | |
| 4.2 Side Club 2 | |
| 2.0 Side Club 3 | |
| 3.0 Choke 1 | |
| 1.4 Choke 2 | |
| 3.0 Choke 3 | |
| 3.0 Lapel 1 | |
| 3.3 Lapel 2 | |
| 4.0 Lapel 3 | |
| 2.0 Pin 1 | |
| 5.0 Slashing Knife 1 | |
| 1.8 Stabbing Knife 1 | |
| 4.0 Stabbing Knife 2 | |
| 2.5 Stabbing Knife 3 | |
| 4.0 Stabbing Knife 4 | |
| 5.0 Upward Knife 1 | |

The first line of the file is the routine's name, the second line its creation date, and the third line lists the total number of techniques included in the routine. The remaining lines list the names of a particular techniques preceded by an effective number of “steps” needed to execute the technique. The effective number of steps is taken from the text files describing each specific technique. For instance, the Stabbing Knife 2 line indicates the technique requires 4.0 “steps” to complete as read from line three of the knife2.txt text file 243 shown in Exemplary File 3 above. The effective number of “steps” is significant because a technique with 4 actual steps will take longer to execute than a technique with 2 actual steps. The value listed in “steps” is actually how much time the student needs to execute a particular technique and return to an on-guard stance relative to a how much time is needed to execute a typical single step. As shown above, the value is not necessarily the number of actual steps in the technique because some steps might be especially long or short.

Tapping “auxiliaries” routine 603 causes the mobile application to call up screen 610 having header 611 as shown in FIG. 6c and to begin executing the routine. Execution comprises audibly announcing and/or visually displaying the technique's name 612, and then waiting for however much time is set aside for the student to execute the technique and return to an on-guard stance before announcing and/or displaying the next technique. The time needed to complete the technique is determined by multiplying the number of relative “steps” quoted for the technique by a preset rate at which a single typical “step” can be completed. Thus, a technique having 2.8 relative “steps” would be displayed for 4.2 seconds if the rate is set to 1.5 seconds/step.

The student physically executes each technique as it is announced, building muscle memory and improving reaction times and execution speeds. The mobile application keeps track of which techniques have been practiced and which have not, freeing the student to concentrate on the techniques, without worrying that any techniques have been overlooked. The display can be turned off and the smartphone pocketed, freeing the student to practice unencumbered.

The function is not limited to use by a single student but can be used simultaneously by two or more students. When used by more than one student at time, the audible output is directed to the devices internal speakers, or to external speakers by wire or wirelessly so that all students can hear the commands at the same time. This an especially useful option when the mobile application is used by an instructor in a class room setting. The instructor first creates a routine suitable for the skill lever of his or her students, as discussed below, and begins execution, directing the output to external speakers. The students then practice the techniques to the air, or work in pairs with one student attacking and the other defending. The instructor is free to observe the students, noting what needs to be worked on and what does not, without keeping track of what techniques have been called.

Screen 610 further includes control panel 613 to provide the student or instructor with control over the execution of the routine. For instance, control panel 613 can include rate display 614 showing the rate at which the “steps” are executed, and “Faster” and “Slower” buttons 615 to speed up or slow down the rate of execution.

Control panel 613 can further include time left display 616 showing how much time is left in the routine. The mobile application initially sums the number of “steps” for each technique and stores that sum. It then decrements that sum by the number of “steps” associated with each technique as it is executed. The time shown in time left display 616 is that decremented sum multiplied by the rate at which a single step would be executed. Thus, time left 616 automatically adjusts whenever the student speeds up or slows down the routine with rate buttons 615 to assure that the full routine is executed. Time left display 616 can be made to count down more smoothly by having the display decrement every second, correcting only when the rate in rate window 614 is changed.

Time left display 616 further includes “Longer” and “Shorter” buttons 617 to allow the student to spend more or less time practicing the routine executed. Lengthening or shortening the routine adds or subtracts steps from the running sum of remain steps, here by a value equal to 60 seconds divided by the rate in rate window 614.

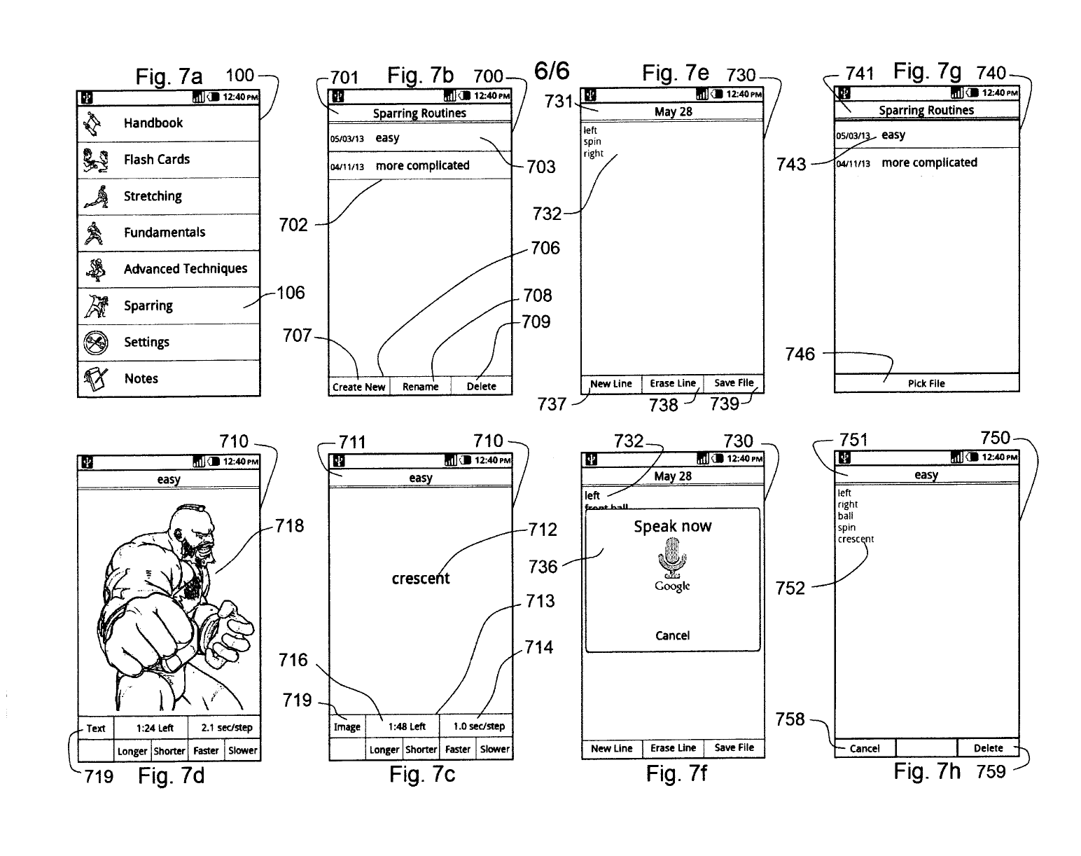

Control panel 613 further includes “Shuffle” button 618 to allow the student to either execute each technique in the order it appears in the routine's text file, or to shuffle the order so that each technique will be executed in an unpredictable order to further challenge the student's reaction time. Control panel 613 further includes “Image” button 619 that instructs the mobile application to display an image of an attacker attacking in a manner for which the defensive technique is particularly well suited in place of technique name 612 (see FIG. 7d).

The mobile application bypasses Screen 600 of FIG. 6b if Advanced Techniques folder 214 of FIGS. 2a-2b contains no stored routines, and transferring control directly to screen 620 where a new routine can be created. Screen 620 can also be activated by tapping “Create New” button 604 in options footer 605.

Screen 620 of FIG. 6 includes header 621 identifying the screen and list 622 showing the types of techniques available for inclusion in the new routine. The list comprises those folders in Kempo Karate folder 207 of FIGS. 2a-2b having a “1” in the fifth position of the binary number on line three of the info.txt file (see Exemplary File 2 above), as discussed in the Handbook section above, providing that there are techniques contained therein having a required level of skill within the student's skill level as designated by his or her belt. If the mobile application determines that a folder contains techniques meeting the function's requirements and student's skill level, then the folder as added to list 622 with name 623 and icon 624 given in the first and second lines of the folder's info.txt file displayed in list 622.

The number of qualifying techniques 625 within applicable folders that fall within the desired skill level is included in list 622. The sum of the “steps” of those techniques is multiplied by whatever the current value for rate 614 (FIG. 6c) is included to indicate the combined time 626 those techniques would take to collectively execute.

The user adds the entirety of all the qualifying knife defense techniques in Knives folder 240 of FIGS. 2a-2b to the new routine by tapping Knives window 627. A category can be added multiple times if the user wishes to give the category more weight than others. The number of times the category has been added appears as numeral 628 located between the category's name and icon.

The student can also add specific techniques by tapping a category's icon, here Shaolin Defenses icon 624 to call up screen 630, here displaying list 636 of the qualifying Shaolin Defenses techniques as identified in header 631. The names and belts, for instance name “SD 12” 632 and its belt icon 633 populate list 636. Tapping a techniques window, for example the “SD 13—No Belt” window 634 adds that technique to the new routine with the number of times that the technique has been selected appearing as numeral 635.

Tapping belt icon 637 calls up Settings screen 400 so that the user can change the desired belt level on the fly to add categories and techniques from a higher belt if desired without changing the categories and techniques already added to the new routine.

The user may wish to cycle through the routine multiple times during a practice session and can add additional passes by tapping “Passes” window 638. Window 638 also display an estimate of how long the routine will take based on the total number of “steps” multiplied by the currently set rate.

The user taps “Return” button 639 to return to screen 620 and there taps “Finished” button 629 to indicate that all desired categories and techniques have been selected, bringing up screen 640 of FIG. 6f. Screen 640 displays the elements 642 of the new routine for inspection and provides the user with several options. The user can simply practice the routine without saving it by selecting “Just Use” button 643, causing the mobile application to transfer control to screen 610 of FIG. 6c where it is executed as described above. Alternatively, the user can elect to save the routine so that it would be available for future use as well.

If saved, the routine will be stored in the Advanced Techniques routines folder 214 with the date based file name, such as 1305271453.txt with the date code meaning 3:53 pm, May 27, 2013. as discussed above, the name of the routine that will appear on screen 600 of FIG. 6b is that name appearing in the first line of the text file. The default name is the month and day, here May 27, as shown in header 641. The user can elect to save the routine with that name by tapping “Save File” button 644, or, alternatively, chose to give the routine a different name.

Tapping “New Name” button 645 brings up pop-up voice recognition window 646 to overlay screen 640 as shown in FIG. 6g. The user then records a new name and the new name appears in header 641. The user can repeat the process until satisfied with the new name, and then tap “Save File” button 644 to save the file. Tapping “Save File” button 644 brings screen 600 back up, now including new routine 609.

The above example uses voice recognition algorithms and processes resident in smartphone 1, or other appropriate devices. Physical and/or software controlled keyboards can also be used as input methods. The user can toggle “Keyboard” button 492 on Settings screen 400 of FIG. 4 to switch between the keyboard and voice recognition methods at any time by tapping menu key 13 of smartphone 1.

### Data Management

In one embodiment, the mobile application opens each of the folders in Kempo Karate folder 207 of FIGS. 2a-2b residing in SD Card 200 and determines whether a candidate folder is applicable for inclusion in list 622. It then opens each of the text files held within that folder to determine which techniques fall within the skill level of the student by comparing the technique's level on line 3 of the text file (see Exemplary File 3 above) to the user's selected belt 426 as set on Settings screen 400 of FIG. 4. The folder's name and icon will appear on list 622 only if the folder includes techniques within the student's skill level. Thus, Kempos window 613 only appears on list because it falls with the function's domain and includes specific techniques within the student's skill level. The mobile application builds a data array (not shown) of qualifying folders and techniques as it works its way through the folders in Kempo Karate folder 207 of FIGS. 2a-2b. That array is used to populate screens 620 and 630, and similar screens, and to provide the data needed to build routines.

In another embodiment, a primary data array (not shown) is built when the mobile application is first started, said primary array having a first part comprising the names, icon addresses, and binary numbers of the folders in Kempo Karate folder 207; and a second part comprising technique names, belt levels, apparent number of “steps”, and the techniques text file address (for use in the Handbook function) on SD Card 200. The mobile application then builds a second, or qualifying, data array from the primary array each time a function is called that requires it, thus saving the significant time required to open and read stored files.

In still another embodiment, the primary data array is stored Kempo. Karate folder 207 on SD Card 200 as data_array.txt 222, as shown in FIGS. 2a-2b and accessed whenever the qualifying data array need to be rebuilt as different functions are called. In yet another embodiment, the primary data file is read into smartphone 1's random access memory at startup, eliminating all but a single file access. And in still another embodiment, the primary data array and all folders, files, images, etc. are a part of the application itself, eliminating all external files completely.

### The Fundamentals and Flash Card Functions

The Fundamentals function is initiated by tapping Fundamentals window 104 on screen 100 of FIG. 1a. It operates like the Advanced Technique function, differing in that it only utilizes Kempo Karate folder 207 folders having a “1” in the fourth position of the binary number in the folder's info.txt file. Fundamental folders include basic kicks and punches, and various block systems, and generally comprise only single “Step” entities. Its routines are created in the same manner as those of the Advanced Technique function. The most significant operational difference is that it is initially set to run for a preset period of time, i.e. three minutes. As it is not based on the total number of steps in the routine, changing the rate does not affect the time remaining.

The Flash Card function in initiated by tapping Flash Card window 102 on screen 100 of FIG. 1b. It draws on data from both the Fundamentals and Advanced Techniques folders. Unlike the Fundamentals and Advanced Techniques functions, the Flash Card function uses only the display screen, flashing technique names up on the screen generally at a rate faster than they could be verbally annunciated to further challenge the user's ability to rapidly bring the technique to mind.

### The Sparring Function

Tapping Sparring function 106 on screen 100 of FIG. 7a brings up Sparring Function screen 700 of FIG. 7b. Screen 700 includes Sparring Routine header 701 and list 702 of all previously saved sparring routines stored in Sparring folder 216 in FIGS. 2a-2b. As with other functions, tapping a routines window, here “easy” routine 703, initiates execution of the routine and brings up screen 710. The Sparring function seeks to sharpen the student's physical reaction time to different types of attacks by annunciating short descriptive words describing an attack, like “crescent” to convey a crescent kick and “left” to convey a punch coming from the user's left side. The “attacks” come in a random order at rapid, at a random, and thus unpredictable rate, forcing the student to react as quickly as possible. Screen 710 includes header 711 providing the name of the routine, and “attack” name 712. It further includes control panel 713 allowing the user to speed up or slow down rate 714, or shorten or lengthen time left 716.

“Shuffle” button 618 of control panel 613 on Advanced Techniques screen 610 is absent as the function has no meaning since the order of the “attacks” is governed by a random number generator and multiple repetitions of the same attack will most likely occur before all the attacks in the routine have been cycled through. Tapping “Image/Text” button 719 replaces attack name 712 with an attack image 718 as shown on FIG. 7d, an especially effective method to improve the student's reaction times because it associates the student's response to a visually perceived attack. The method is most dramatic when smartphone 1 is coupled to a big screen display either wirelessly or through an HDMI cable. Attack images can be in any suitable format (i.e. .jpg, .png, .tif, etc.) and stored on SD Card 200 in Icons folder 260 within Kempo Karate folder 207, or in Pictures folder 204 of FIGS. 2a-2b, or elsewhere. Re-tapping “Image/Text” button 719 returns to textual display 712 of the attack. As with other functions, the screen can be turned off to conserver power and prevent inadvertent screen and options triggering if smartphone 1 is pocketed; the audio output will continue to announce new attacks.

Tapping “Create New” button 707 on screen 700 initiates the process of creating a new sparring routine, bringing up screen 730 of FIG. 7e. The process is also automatically initiated if Sparring folder 216 of FIGS. 2a-2b is empty. Screen 730 includes header 731 providing the default name the new routine will have if accepted as previously discussed and list 732 of the attacks to be included in the routine, initially empty but here showing several lines already filled in. New lines are added to list 732 by tapping “New Line” button 737, bringing up pop-up voice recognition window 736, allowing the user to dictate the routine as desired as shown in FIG. 7f. Tapping “Erase Line” button 738 removes the last line of the list. Tapping “Save File” button 738 initiates the save routine process as discussed above.

### Deleting and Renaming Routines

The user may wish to rename a previously saved routine, or eliminate it altogether. Selecting “Delete” button 709 on screen 700 of FIG. 7b brings up screen 740 shown in FIG. 7g wherein options panel 706 of screen 700 is replaced by “Pick File” instruction panel 746, instructing the user to pick the file to be deleted. Tapping a file name brings up delete screen 750 of FIG. 7h wherein the selected routine, here “easy” 743, is named in header 751, and displayed in list 752. The user can then delete the routine from Sparring folder 216 by tapping “Delete” button 759, or cancel the process by tapping “Cancel” button 758. Tapping either button returns the user to screen 740 of FIG. 7g and tapping back key 14 on smartphone 1 returns the user to screen 700 of FIG. 7b. Tapping back key 14 returns the user to screen 100 for the selection of new function.

Tapping “Rename” button 708 on screen 700 of FIG. 7b also bring up screen 740 of FIG. 7g where selecting a routine instructs the mobile application to transfer to the save file process discussed above with respect to screen 640 of FIGS. 6f and 6g. Although described with respect to managing the routines stored in Sparring folder 216, the above discussed deleting and renaming processes are used with all function.

### The Notes Function

The user may wish to create personal notes with respect to some particular teaching, class schedule or upcoming tournaments. Tapping Notes Function 108 initiates the note taking process, bringing up a list of previous stored notes, if any, for subsequent inspection, or jumping to a create note screen where the note is created either by keyboard entry or voice recognition as methods previously discussed.

Certain examples can include processes that can be implemented using, for example, computer readable instructions that can be used to facilitate mobile Martial Arts training applications for students and instructors. The example processes can be performed using a processor, a controller and/or any other suitable processing device. For example, the example processes and methods can be implemented using coded instructions (e.g., computer readable instructions) stored on a tangible computer readable medium such as a flash memory, a read-only memory (ROM), and/or a random-access memory (RAM), or accessed over the internet. As used herein, the term tangible computer readable medium is expressly defined to include any type of computer readable storage. Additionally or alternatively, the example functions and methods can be implemented using coded instructions (e.g., computer readable instructions) stored on a non-transitory computer readable medium such as a flash memory, a read-only memory (ROM), a random-access memory (RAM), a CD, a DVD, a Blu-ray, a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium.

Alternatively, some or all of the example processes can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes can be implemented manually or as any combination(s) of any of the foregoing techniques, for example, any combination of firmware, software, discrete logic and/or hardware. Further, although example processes may be described with reference to a particular order and/or structure, other methods of implementing the processes may be employed. For example, the order of execution of the functions can be changed, and/or some of the functions described may be changed, eliminated, sub-divided, or combined.

While particular embodiments of the invention have been shown and described, it will be obvious to those skilled in the art that changes and modifications may be made therein without departing from the invention in its broader aspects.

I claim:

1. A computer-implemented method for martial arts training, said method comprising providing audible annunciation of one or more martial arts techniques.

2. The method of claim 1 further comprising providing a user with a method to construct a series of martial arts techniques to practice either in order or in a random sequence.

3. The method of claim 2 wherein said method to construct a series of martial arts techniques includes presenting a list of techniques to the user to choose from.

4. The method of claim 3 wherein said list of techniques is filtered to provide the user only with techniques appropriate to a preselected level of proficiency.

5. The method of claim 2 further providing a method to store said series of martial arts techniques for subsequent use.

6. The method of claim 2 wherein the temporal spacing between the annunciations of said martial arts techniques in said series of martial arts techniques is dependent one or more attributes of said martial arts techniques.

7. The method of claim 6 wherein said attribute of said martial arts techniques is the number of steps involved in each of said martial arts techniques.

8. The method of claim 6 wherein said temporal spacing between said annunciations of said martial arts techniques is user adjustable.

9. The method of claim 1 further comprising making said computer-implemented method available on a mobile device.

10. A computer-implemented method for martial arts training, said method comprising providing a first computer program to process martial arts training information generated by a second computer program.

11. The method of claim 10 wherein said first computer program provides a user with a method to select which martial arts training information to use when more than one set of martial arts training information is present.

12. The method of claim 10 wherein said first computer program provides a user with a method to add and/or subtract martial arts training information to the martial arts training information generated by said second computer program.

13. The method of claim 10 wherein the second computer program is resident on a computer different from the computer said first computer program is resident on and the martial arts training information generated by said second computer program is subsequently conveyed to the computer hosting said first computer program.

14. The method of claim 10 further comprising making said computer-implemented method for martial arts training available on a mobile device.

15. A computer-implemented method for martial arts training, said method comprising providing both audible and visual methods to present martial arts training information.

16. The method of claim 15 further providing means for a user to switch between said audible and said visual presentations of said martial arts training information.

17. The method of claim 15 further providing means for a user to select simultaneous audio and visual presentation of said martial arts training materials.

18. The method of claim 15 wherein said presentation of martial arts training information comprises an image.

19. The method of claim 15 wherein said presentation of martial arts training information comprises a video.

20. The method of claim 15 further comprising making said computer-implemented method for martial arts training available on a mobile device.
